(19) United States
(12) Patent Application Publication
(10) Pub. No.: US 2013/0270398 A1
(43) Pub. Date: Oct. 17, 2013

(54) Flower Support Collar for Vases

(71) Applicant: Tracie Radermacher, Minneapolis, MN (US)

(72) Inventor: Tracie Radermacher, Minneapolis, MN (US)

(21) Appl. No.: 13/444,526

(22) Filed: Apr. 11, 2012

(51) Int. Cl. A47G 7/02; B23P 11/02

(52) U.S. Cl. 248/27.8; 29/451

(57) ABSTRACT

A collar for surrounding the stem portion of a cut flower or flowers for supporting the flower(s) generally vertically in an open top vase comprises a generally planar piece of foam sponge material whose shape corresponds to that of the cross-section of a vase just below its open top. An aperture is formed through the thickness of the foam sponge material and a slit is formed vertically through the material that extends from a perimeter edge thereof to the aperture so that flower stem(s) can enter the aperture via the slit. When the collar is inserted into the vase and allowed to self-expand against the vase interior, the blooms are held upright in a central location in the vase.

### BACKGROUND OF THE INVENTION

I. Field of the Invention

This invention relates generally to floral displays, and more particularly to a device for supporting cut or artificial flowers in vases.

II. Discussion of the Prior Art

It is difficult to hold a cut flower or an artificial flower on a stem erect in a vase when the upper open end of the vase is large in comparison with the diameter of the flower stem. The tendency is for the flower to lie against the rim of the vase rather than to stand vertically. The prior art is replete with devices that can be placed in or on a vase to support one or more stemmed flowers in a desired arrangement. Vases have been designed with a relatively small diameter circular opening for holding a single, long-stemmed rose generally vertical. Similarly, and as shown in the Tweddell U.S. Pat. No. 3,142,936, vase inserts have been designed to accommodate a flower bouquet. Here, a semi-rigid insert has a plurality of holes arranged in a predetermined pattern, allowing long-stemmed flowers to be inserted through the holes and into a vase to support the flowers in a desired arrangement. Similarly, the Wimp, Jr. published U.S. application 2003/0089033 discloses a flower organizer for supporting a plurality of long-stemmed flowers in a desired arrangement in which a flat, heart-shaped card is perforated by a plurality of holes along the perimeter of the card, each for receiving a stem of a long-stemmed rose or other bloom therein. The card is designed to rest atop a vase and, in this way, the flowers are made to stand vertically with respect to the vase. Because the heart-shaped card can shift relative to the vase, the desired pattern will not be maintained.

U.S. Pat. No. 5,758,452 to Mattecci describes a floral arranging aid for holding flowers in a vase where the aid comprises a vase top cover of plastic or cardboard having a plurality of partially scored apertures that can be readily pierced by a flower stem. The cover has an adhesive on its undersurface for adhering it to the top of a vase. When the apertures are populated, the card, resting atop the vase is easily visible and detracts from the overall appearance of the floral presentation.

It is accordingly an object of the present invention to improve upon the prior art by providing a way to support a long-stemmed flower in a vertical orientation in a vase whose open upper end is much greater in area than the cross-sectional dimension of the flower stem to be displayed.

### SUMMARY OF THE INVENTION

In accordance with the present invention, an insert of a foam sponge material and having a predetermined thickness is shaped to correspond to a predetermined cross-sectional shape of a vase below its open top. When compressed, the foam sponge material will fit within the top opening of the vase and will self-expand to support itself with respect to the interior wall of the vase proximate its open upper end. The foam sponge insert is provided with an aperture extending through its thickness dimension and a slit, also through the thickness dimension, extends from the peripheral edge of the insert to the aperture. This allows a stem of at least one flower to be passed through the slit into the aperture to be supported upright upon insertion of the foam sponge insert into the open top of the vase.

### DESCRIPTION OF THE DRAWINGS

The foregoing features, objects and advantages of the invention will become apparent to those skilled in the art from the detailed description of a preferred embodiment, especially when considered in conjunction with the accompanying drawings in which like numerals in the several views refer to corresponding parts.

FIG. 1 is a perspective view of the flower support collar comprising a preferred embodiment of the present invention; and

FIG. 2 is a side elevational view of a flower supported in a vase with the aid of the flower support collar of FIG. 1.

### DESCRIPTION OF THE PREFERRED EMBODIMENT

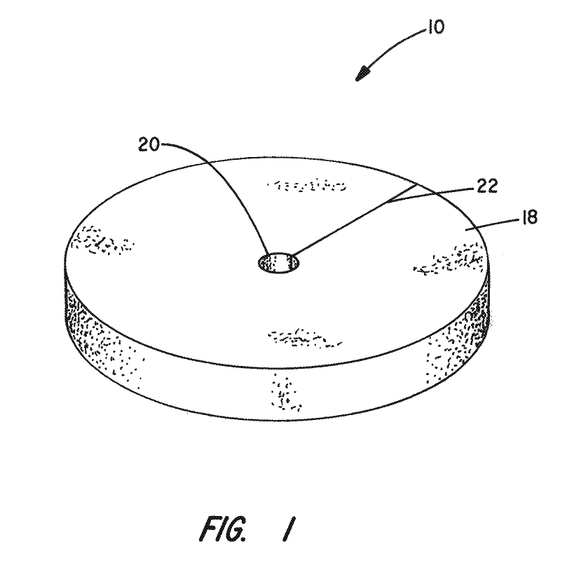

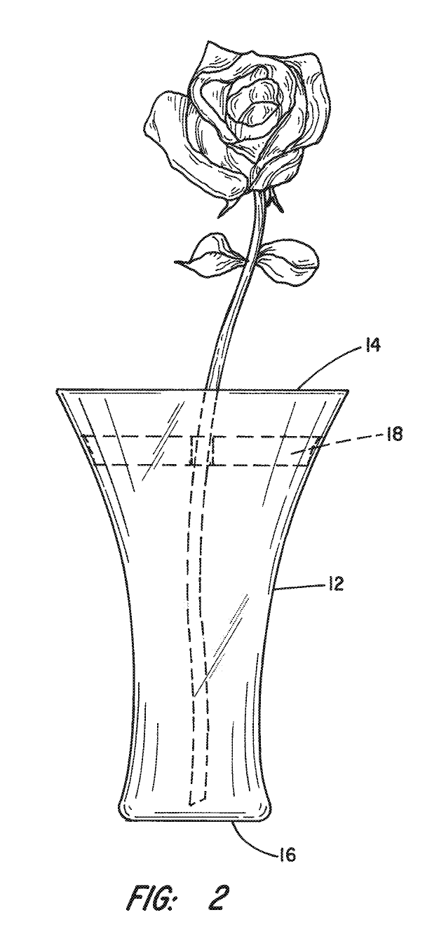

Referring to the drawings, FIG. 1 illustrates a flower support collar for use with a vase having a predetermined cross-sectional shape proximate the top opening of the vase. It is indicated generally by numeral 10 and comprises a piece of foam sponge material of a predetermined thickness that is shaped to conform to the predetermined cross-sectional shape slightly below the top opening of a vase. For exemplary purposes only, FIG. 2 shows a fluted vase 12 having an open top 14 and a closed bottom 16. In FIG. 2 the predetermined shape just below the top opening of the vase is shown to be circular and, as such, the foam sponge material 18 comprising the flower support collar 10 is also circular in shape in its plan view and is of a slightly larger diameter than the open top 14 of the vase 12.

While for illustrative purposes only, the vase is shown as having a circular profile, those skilled in the art will appreciate that the foam flower support collar 10 can be shaped to conform to vases having oval or polygonal cross-sectional shapes as well.

In FIG. 1, the foam sponge material 18 has an aperture 20 centrally located and a slit 22 extends from the perimeter of the foam collar 10 to the aperture 20. This permits the stem of a flower to be passed through the slit 22 into the aperture 20 and because the foam material 18 is quite resilient, it can be compressed to a reduced diameter by overlapping the material on one side of the slit 22 with the material on the opposite side of the slit. To facilitate overlapping of foam portions on opposite sides of the slit 22, the upper surface of the foam layer on one side of the slit may be made to taper to a lesser thickness over a short distance while the bottom surface on the opposite side of the slit also tapers to a lesser thickness, thus avoiding a doubling of the foam thickness proximate the slit when overlapped. Overlapping in the manner described serves to close the aperture 20 about the stem of the flower and permits the support collar 20 to be inserted into the top opening 14 of the vase 12 to a location slightly below the open top 14 of the vase as seen in FIG. 2.

Again, without limitation, the sponge material 18 may range in thickness, preferably between 0.5 inch to 2.0 inch and, as mentioned, would be shaped to correspond to the interior cross-sectional contour of the vase with which it is to be used. Because the stem of the flower is captured in the aperture 20, and the aperture 20 is generally centrally located, the flower will be supported upright in the center of the vase once the collar 10 containing the stem of the flower is inserted into the open top of the vase.

The foam sponge material itself may comprise polyurethane, polypropylene, polyethylene or any other suitable resilient polymer.

A further benefit afforded by the flower support collar 10 is that when it is appropriately placed within the vase in the manner described, it not only supports the associated flower in a vertical orientation, but also limits evaporation of water commonly used in a vase to prolong the original condition of the flower over time.

This invention has been described herein in considerable detail in order to comply with the patent statutes and to provide those skilled in the art with the information needed to apply the novel principles and to construct and use such specialized components as are required. However, it is to be understood that the invention can be carried out by specifically different equipment and devices, and that various modifications, both as to the equipment and operating procedures, can be accomplished without departing from the scope of the invention itself.

What is claimed is:

1. A flower support device for a vase having a predetermined cross-sectional shape proximate a top opening of said vase comprising:
(a) an insert of a foam sponge material of a thickness in a range of from 0.5 inch to 2.0 inch shaped to correspond to said predetermined cross-sectional shape and to fit within the top opening of the vase when compressed, the insert including at least one aperture extending through a thickness dimension thereof and with a slit extending from a peripheral edge of the insert to the aperture whereby a stem of at least one flower may be passed through the slit into the aperture to be supported upright upon insertion of the insert into the open top of the vase.

2. The flower support device of claim 1 wherein the predetermined cross-sectional shape is one of circular, oval or polygonal.

3. The flower support device of claim 1 wherein the aperture is sized to close about the stem of the at least one flower when the insert is compressed to fit within the top opening of the vase.

4. The flower support device of claim 1 wherein the foam sponge material is selected from a group consisting of polyurethane, polypropylene and polyethylene.

5. The flower support device of claim I wherein the thickness dimension tapers to a lesser thickness along one major surface of the foam material proximate one side of the slit and along an opposite major surface of the foam material proximate the other side of the slit.

6. A method for positioning and holding flowers upright in a vase comprising the steps of:
(a) providing a generally planar foam sponge vase insert of a predetermined thickness dimension and a shape corresponding to a shape of a vase cross-section immediately below its top opening, the vase insert having an aperture through the thickness dimension generally centrally located on the vase insert and a slit formed through the thickness dimension and extending from a perimeter of the vase insert to the aperture;
(b) fitting a stem of a flower to be displayed in said vase through the slit and into the aperture of the vase insert; and
(c) compressing the vase insert and inserting same through the top opening of the vase, allowing the vase insert to self-expand against an interior wall of the vase immediately below its top opening, such that the flower stands erect proximate a center of the vase.
